(19) United States
(12) Patent Application Publication
(10) Pub. No.: US 2017/0053568 A1
(43) Pub. Date: Feb. 23, 2017

(54) INFLATABLE BALLASTED A-FRAME SIGN WITH SEALED HINGE

(71) Applicant: Gary Aires, San Diego, CA (US)

(72) Inventor: Gary Aires, San Diego, CA (US)

(21) Appl. No.: 14/829,682

(22) Filed: Aug. 19, 2015

(51) Int. Cl. G09F 7/00; F16B 1/00

(52) U.S. Cl. CPC G09F 7/00; F16B 1/00; F16B 2001/0028

(57) ABSTRACT

A novel advertising sign is described, composed of an inflatable mattress form that can be folded into a V-shape along a welded plastic hinge, held in place by Velcro® connectors or other means. The form can then hold a cover with advertising on it, while the mattress form can be weighted down with water ballast added to the bottom ends of the mattress.

### FIELD OF THE INVENTION

The present invention relates to inflatable advertising means and, more particularly, to a method of preventing inflatable signs from rolling up and moving when designed to maintain an angular shape.

### BACKGROUND OF THE INVENTION

Inflatable advertising comes in many sizes and shapes. There is a set of small advertising media, based on the use of inflatable “mattresses” with fabric covers that contains the advertising. The present invention fits within that category.

The current state of the art in such small, inflatable signs revolves around a multiple-celled, inflatable medium that resembles an air mattress. This medium can be folded at several points along its length in order to fit into a fabric or plastic sign cover. The cover is often built into a constraining envelope by means of straps or connectors that hold it into a geometric shape, usually triangular.

The stiffening of said sign cover by the air mattress of inflatable sign allows the sign to maintain its shape. However, since the mattress shape can be folded at multiple points, the sign cover may be pushed out of shape by inadvertent folds at other than the sign's corners.

Lightweight signs such as the present invention and others in the art can blow away in a wind during outdoor use. A system of ballasting of the sign body would prevent inadvertent movement.

The present invention with a hinging system to prevent folds other than the designed corners is designed exclusively for temporary or permanent use and easy storage, with improved cost benefits, decreased weight, portability, and minimal storage size.

### OBJECTS OF THE INVENTION

It is an object of the invention to provide a sign frame and stiffener that folds at pre-established points to support inflatable signage.

It is another object of the invention that the invention be light-weight, easy to store and easy to mate with fabric or plastic sign covers.

It is another object of the invention that the light-weight invention be able to take on ballast weight to minimize movement from the wind.

It is another object of the invention that the invention be inflatable at a single point with a sturdy inflation aperture.

It is another object of the invention to be easily and rapidly inflated using commercially available low-pressure inflators or human breath.

It is another object of the invention to be easily and rapidly deflated.

It is another object of the invention to be quickly and easily folded for stowage.

It is another object of the invention that it be ballasted with water that is added to the bottom edges of the sign via apertures.

### SUMMARY OF THE INVENTION

The present invention is an inflatable, flat, airtight, frame that possesses one or more hinge points that are predetermined and sealed. This frame can be covered easily with a fabric or plastic sign which slips over the frame. The sign material cover usually has one or more connecting means that hold the sign in a simple geometric shape, such as a triangle, braced by the inflatable frame.

The frame possesses a ballast port that permits easy addition of water weight to the bottom edges of the sign, to increase stability and reduce the chance that the sign will move in the presence of wind.

The length of the frame depends on the size of the sign, and the assembled sign comprises roughly two sides of an isosceles triangle. The frame is equipped with one or more valves that permit fast, easy, low-pressure inflation and rapid deflation from any number of commercially available inflators.

The cover is comprised of a tough fabric that conceals all of the frame including the inflation valve. The cover is comprised of materials including acrylic, polyester, nylon, and other fabrics.

When deflated, the frame and sign may be folded for easy stowage.

### BRIEF DESCRIPTION OF THE DRAWINGS

FIG. 1. Top view of the inflatable frame

FIG. 2. Perspective view of the inflatable frame

FIG. 3. Perspective view of the sign with the folded frame inserted

### DETAILED DESCRIPTION

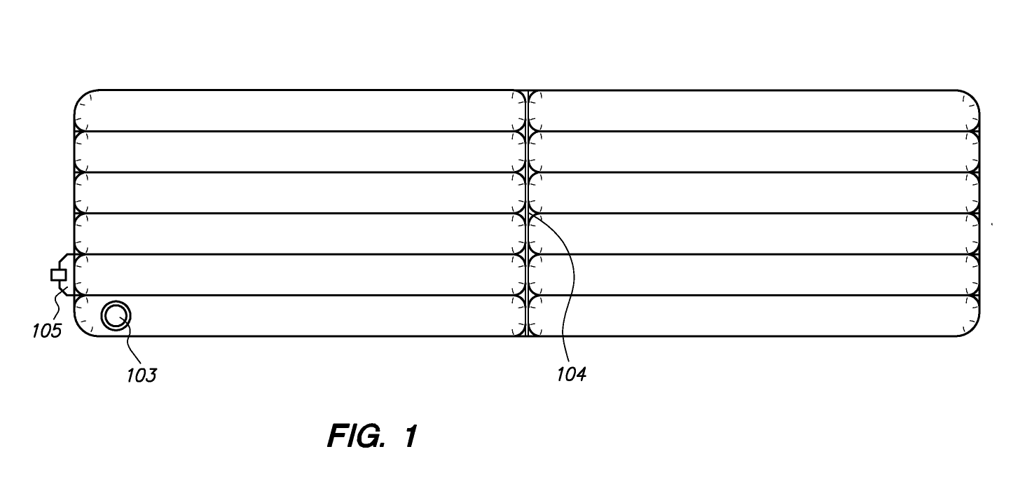

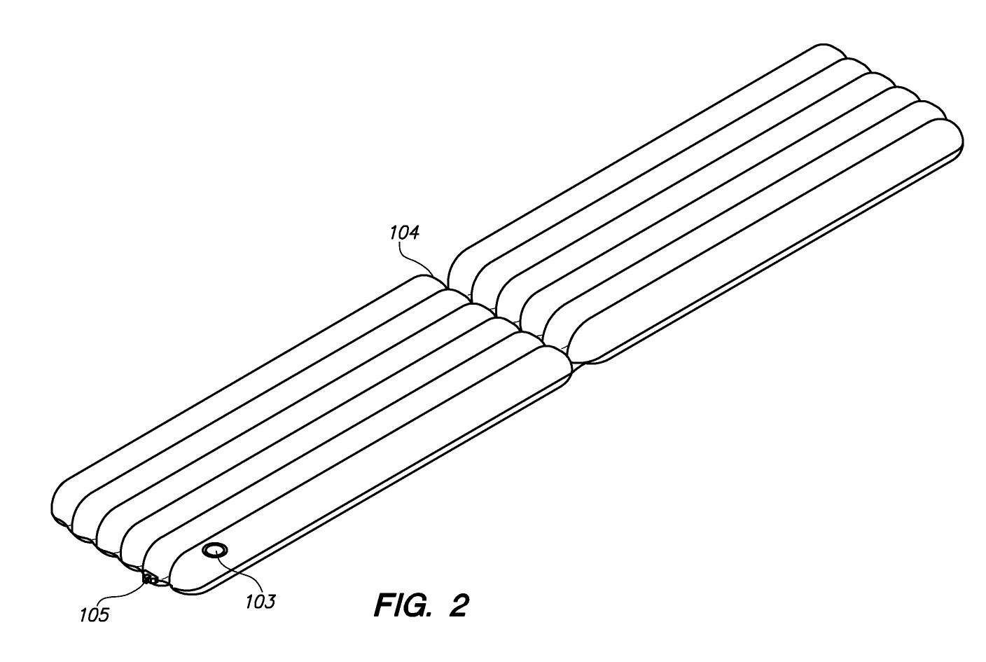

In FIG. 1, the invention 101 is flat in shape without the advertising cover 102, showing the ballast valve 103. The inflation port 105 is shown at one end of the inflated frame 101. In FIG. 2, the device is shown folded about the sealed hinge 104.

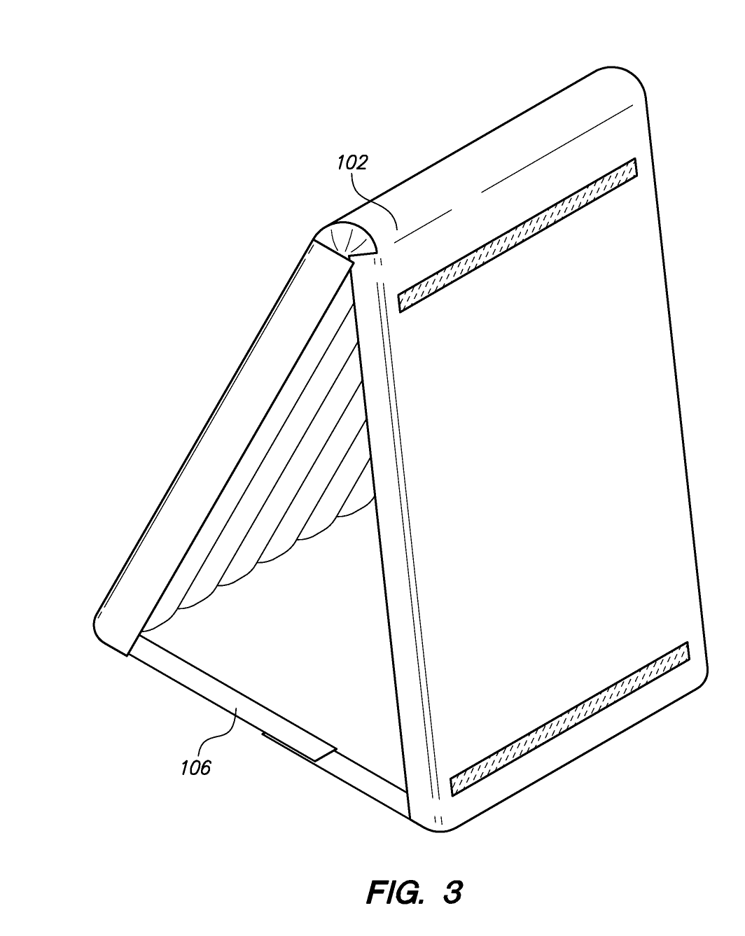

In FIG. 3. the invention 101 is shown with the connectors 106 holding it in a characteristic two-sides-of-a-triangle shape. The cover 102 has had the inflated frame 101 inserted to hold the cover 102 in the desired triangular shape.

In the preferred embodiment, the inflatable frame 101 is comprised of soft plastic and the cover 102 is comprised of canvas. In the preferred embodiment, the ballast valve 103 is a commercial off-the-shelf snap-close water valve.

This invention has other applications, potentially, and one skilled in the art could discover these. The explication of the features of this invention does not limit the claims of this application; other applications developed by those skilled in the art will be included in this invention.

What is claimed is:

1. An inflatable advertising sign, the advertising sign comprised of an inflatable mattress, an advertising cover, and connectors,
the inflatable mattress comprised of two inflatable sections connected to each other at a welded hinge, the welded hinge extending across the width of the inflatable mattress, the hinge positioned such that the inflatable mattress can be folded along the welded hinge to form a V-shape,
the inflatable sections each possessing an inflation valve and a ballast valve, the inflation valve capable of being sealed such that air cannot escape the inflatable section after the inflatable section is inflated, the ballast valve a snap-close water valve,
the connectors are straps attached to the ends of the inflatable mattress such that when the inflatable mattress is folded along the welded hinge, the connectors can be attached to each other by a connector attachment means and thereby hold the folded mattress in its folded shape,
the advertising cover is a flat cloth or plastic sign that fits over the folded inflatable mattress.

2. An inflatable advertising sign as in claim 1 where the connector attachment means is selected from the list of hook and loop attachment device, snaps, and ties.

3. An inflatable advertising sign as in claim 1 where the material comprising the inflatable mattress is selected from the list of canvas, plastic, or neoprene.
